(19) United States
(12) Patent Application Publication
(10) Pub. No.: US 2016/0275634 A1
(43) Pub. Date: Sep. 22, 2016

(54) USING LARGE DATA SETS TO IMPROVE CANDIDATE ANALYSIS IN SOCIAL NETWORKING APPLICATIONS

(71) Applicant: Linkedln Corporation, Mountain View, CA (US)

(72) Inventors: Satpreet Harcharan Singh, Chicago, IL (US); Suman Sundaresh, Los Altos, CA (US)

(21) Appl. No.: 14/662,007

(22) Filed: Mar. 18, 2015

(51) Int. Cl. G06Q 50/20; G06Q 50/00; H04L 12/58; G06F 17/30

(52) U.S. Cl. CPC G06Q 50/2053; G06F 17/3053; G06F 17/30867; G06Q 50/01; H04L 51/046

(57) ABSTRACT

A system and method for using large data sets to improve candidate analysis in social networking applications is disclosed. A social networking system stores member data for a plurality of members of a social networking system in a database. The social networking system receives a potential applicant information request from a computer system associated with a first education institution. In response to receiving a potential applicant information request from a computer system associated with the first education institution, the social networking system generates potential applicant data based, at least in part, on the stored member data in the database associated with the social networking system and transmits the generated potential applicant data to the computer system associated with the first education institution. The social networking system receives, associated with the first education institution, an applicant offer message intended for display to at least one member of the social networking system.

### TECHNICAL FIELD

The disclosed implementations relate generally to the field of social networks and, in particular, to a system for generating predictions based on analysis of large scale historic data.

### BACKGROUND

The rise of the computer age has resulted in increased access to personalized services online. As the cost of electronics and networking services drop, many services that were previously provided in person are now provided remotely over the Internet. For example, entertainment has increasingly shifted to the online space with companies such as Netflix and Amazon streaming television shows and movies to members at home. Similarly, electronic mail (e-mail) has reduced the need for letters to be physically delivered. Instead, messages are sent over networked systems almost instantly. Similarly, online social networking sites allow members to build and maintain personal and business relationships in a much more comprehensive and manageable manner.

One important application of new computer technologies is allowing users to explore and learn. Some education tools are being moved such that they can be accessed directly over the Internet. For example, massive open online courses (MOOCs) allow users from different parts of the world to all experience the same education experiences. In addition, even non-network based education can be enhanced by improving access to information about education institutions, programs, and opportunities to interested parties. Networked computer systems can collect and process large amounts of data to streamline and enhance education opportunities.

### DESCRIPTION OF THE DRAWINGS

Some implementations are illustrated by way of example and not limitation in the figures of the accompanying drawings, in which:

FIG. 1 is a network diagram depicting a client-server system that includes various functional components of a social networking system, in accordance with some implementations.

FIG. 2 is a block diagram illustrating a client system, in accordance with some implementations.

FIG. 3 is a block diagram illustrating a social networking system, in accordance with some implementations.

FIG. 4 is a member interface diagram illustrating an example of a member interface, according to some implementations.

FIG. 5 depicts a block diagram of an exemplary data structure for the member profile data for storing member profiles in accordance with some implementations.

FIG. 6 is a flow diagram illustrating a method, in accordance with some example embodiments, for using large data sets to improve candidate analysis in social networking applications in accordance with some implementations.

FIGS. 7A-7B are flow diagrams illustrating a method, in accordance with some example embodiments, for determining a list of suitable potential applicants for an education institution based on stored data.

FIG. 8 is a block diagram illustrating architecture of software, which may be installed on any one or more of devices, in accordance with some implementations.

FIG. 9 is a block diagram illustrating components of a machine, according to some example embodiments.

Like reference numerals refer to corresponding parts throughout the drawings.

### DETAILED DESCRIPTION

The present disclosure describes methods, systems, and computer program products for using large data sets to provide improved candidate analysis tools for education institutions through social networking applications. In the following description, for purposes of explanation, numerous specific details are set forth to provide a thorough understanding of the various aspects of different implementations. It will be evident, however, to one skilled in the art, that any particular implementation may be practiced without all of the specific details and/or with variations, permutations, and combinations of the various features and elements described herein.

Education institutions of all kinds are facing increasing competition for the best qualified applicants. As such, the education institutions have a need for improved tools for identifying good candidates and recruiting those candidates. A sufficiently large social networking system stores member data for a large number of members (e.g., profile data for millions of members) and uses the large data set to provided improved tools for identifying and recruiting potential applicants.

In some example embodiments, the social networking system receives a request from a first education institution. In some example embodiments, the request includes a list of one or more applicant criteria describing good candidates for the first education institution. Using profile data for members of the social networking system as well as interest data provided by those members, the social networking system identifies one or more candidates for the education institution.

Once one or more candidates are identified, the social networking system enables the respective education institution to message the prospective applicants. In some example embodiments, the education institution creates (or has the social networking system create) an advertisement that is inserted into webpages generated by the social networking system for display at a client system (e.g., an advertisement displayed in the margins of a member activity feed page).

In some example embodiments, information about members' (e.g., potential applicants) education institution interest (or other demographic information) is only used if the member opts in to a program allowing such information to be analyzed and potentially shared. In other example embodiments, only information that has already been stripped of personally identifiable information is shared with education institutions.

In other example embodiments, the education institution creates personalized messages to send to specific identified potential candidates. For example, the social networking system can enable the education institution to send an email message to the potential applicant, an in-system message to the potential applicant, or otherwise directly contact the member. In some example embodiments, the social networking system generates an applicant interest score for each potential applicant. An applicant interest score is generated based on member qualification data, other education institutions the member has expressed interest in, geographic data about the member, and demographic data about the member. In some example embodiments, the application interest score represents the likelihood that the member would be interested in attending the first education institution.

In some example embodiments, the education institution can use the generated applicant interest score to determine which specific method of contacting to use for each potential applicant. For example, for members with a high generated applicant interest score (e.g., the social networking system predicts the member has a high likelihood of being interested in attending the first education institution) the education institution will send personalized messages. For members with low generated applicant interest scores the education institution will send passive advertisements. In some example embodiments, the degree to which a candidate matches the one or more criteria from the education institution will be used to determine whether to message the potential applicant.

In some example embodiments, the education institution can also request statistical information about members interested in the first education institution. This information can be analyzed and compared against statistical information for similar education institutions to develop a specific recruitment plan for the first education institution.

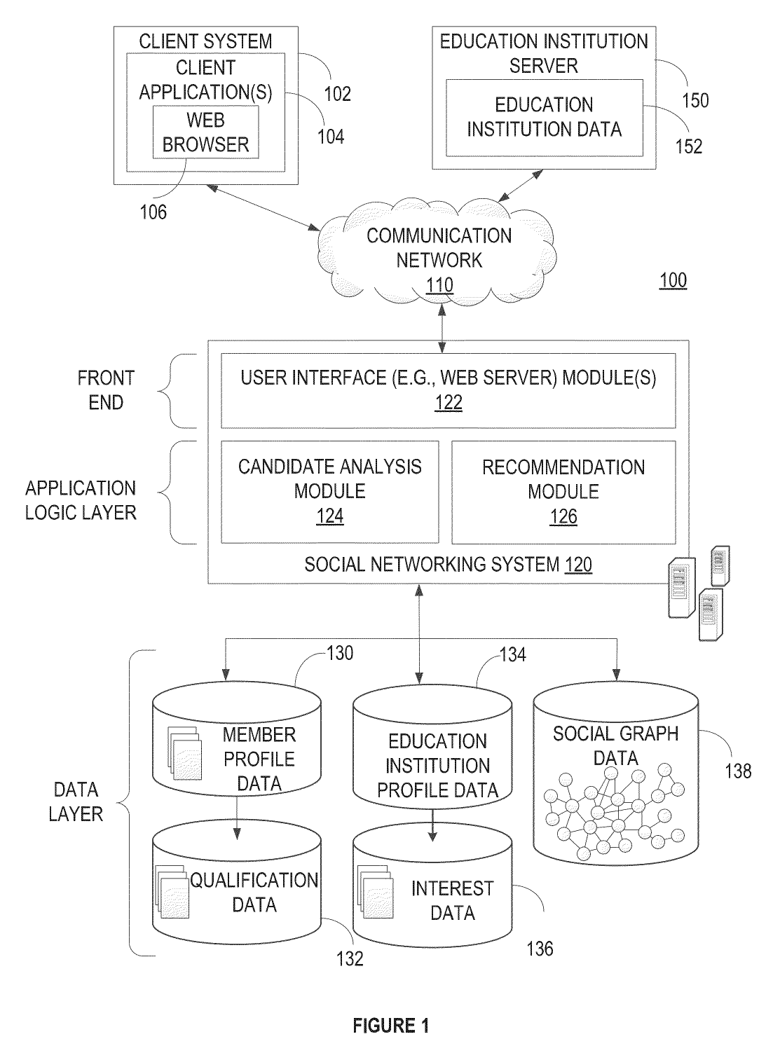

FIG. 1 is a network diagram depicting a client-social networking system environment 100 that includes various functional components of a social networking system 120, in accordance with some implementations. The client-social networking system environment 100 includes one or more client systems 102, a social networking system 120, and one or more other education institution servers 150. One or more communication networks 110 interconnect these components. The communication networks 110 may be any of a variety of network types, including local area networks (LANs), wide area networks (WANs), wireless networks, wired networks, the Internet, personal area networks (PANs), or a combination of such networks.

In some implementations, a client system 102 is an electronic device, such as a personal computer (PC), a laptop, a smartphone, a tablet, a mobile phone, or any other electronic device capable of communication with a communication network 110. The client system 102 includes one or more client applications 104, which are executed by the client system 102. In some implementations, the client application(s) 104 include one or more applications from a set consisting of search applications, communication applications, productivity applications, game applications, word processing applications, or any other useful applications. The client application(s) 104 include a web browser 106. The client system 102 uses the web browser 106 to communicate with the social networking system 120 and displays information received from the social networking system 120.

In some implementations, the client system 102 includes an application specifically customized for communication with the social networking system 120 (e.g., a LinkedIn iPhone application). In some example embodiments, the social networking system 120 is a server system that is associated with a social networking service. However, the social networking system 120 and the server system that actually provides the social networking service may be completely distinct computer systems.

In some implementations, the client system 102 sends a request to the social networking system 120 for a webpage associated with the social networking system 120 (e.g., the client system 102 sends a request to the social networking system 120 for an updated web page associated with an education institution). For example, a member of the client system 102 logs onto the social networking system 120 and clicks to view educational information on a dedicated web page of the social networking system 120. In response, the client system 102 receives the requested data (e.g., information about schools and enrollment) and displays them on the client system 102.

In some implementations, as shown in FIG. 1, the social networking system 120 is generally based on a three-tiered architecture, consisting of a front-end layer, application logic layer, and data layer. As is understood by skilled artisans in the relevant computer and Internet-related arts, each module or engine shown in FIG. 1 represents a set of executable software instructions and the corresponding hardware (e.g., memory and processor) for executing the instructions. To avoid unnecessary detail, various functional modules and engines that are not germane to conveying an understanding of the various implementations have been omitted from FIG. 1. However, a skilled artisan will readily recognize that various additional functional modules and engines may be used with a social networking system 120, such as that illustrated in FIG. 1, to facilitate additional functionality that is not specifically described herein. Furthermore, the various functional modules and engines depicted in FIG. 1 may reside on a single server computer or may be distributed across several server computers in various arrangements. Moreover, although depicted in FIG. 1 as a three-tiered architecture, the various implementations are by no means limited to this architecture.

As shown in FIG. 1, the front end consists of a user interface module (e.g., a web server) 122, which receives requests from various client systems 102, and communicates appropriate responses to the requesting client systems 102. For example, the user interface module(s) 122 may receive requests in the form of Hypertext Transport Protocol (HTTP) requests, or other web-based, application programming interface (API) requests. The client system 102 may be executing conventional web browser 106 applications or applications that have been developed for a specific platform to include any of a wide variety of mobile devices and operating systems.

As shown in FIG. 1, the data layer includes several databases, including databases for storing data for various members of the social networking system 120, including member profile data 130, qualification data 132 (e.g., data describing the qualifications of one or more members of the social networking system 120), education institution profile data 134, interest data 136 (e.g., data that describes which education institutions, if any, a particular member is interested in), and a social graph database 138, which is a particular type of database that uses graph structures with nodes, edges, and properties to represent and store data. Of course, with various alternative implementations, any number of other entities might be included in the social graph (e.g., companies, organizations, schools and universities, religious groups, non-profit organizations, governmental organizations, non-government organizations (NGOs), and any other group) and, as such, various other databases may be used to store data corresponding with other entities.

Consistent with some implementations, when a person initially registers to become a member of the social networking system 120, the person will be prompted to provide some personal information, such as his or her name, age (e.g., birth date), gender, interests, contact information, home town, address, educational background (e.g., schools, majors, etc.), current job title, job description, industry, employment history, skills, professional organizations, memberships with other online service systems, and so on. This information is stored, for example, in the member profile database 130. In some example embodiments, the social networking system 120 will also prompt the person to determine whether that person is interested in attending one or more schools in the future.

In some implementations, the member profile data 130 includes qualification data 132. In other implementations, the qualification data 132 is distinct from, but associated with, the member profile data 130. The qualification data 132 stores data for at least some of the members of the social networking system 120. Qualification data 132 includes, but is not limited to, test scores, employment history, demographic information, work history, education history, grade point averages, hobbies, accomplishments, member ratings, recommendations, and so on.

The education institution profile data 134 also stores data related to education institutions represented on the social networking system 120 and their students. Thus, members of the social networking system 120 may be associated with specific education institutions. In addition, education institution profile data 134 includes information that describes the location of the education institution, the programs it offers, the demographic information of its students, the costs of the education institution, scholarship programs offered by the education institution, important school dates (e.g., deadlines, term beginning and ending dates, holidays, and so on), ranking information on the education institution, enrollment statistics, and other information.

In some example embodiments, the interest data 136 stores data received from a plurality of members that indicates the specific schools (or other educational opportunities) that a specific member is interested in pursuing. In some example embodiments, the interest data 136 for a respective member is received directly from the member. For example, a member selects one or more universities as potential educational opportunities that the member is interested in pursuing. In other example embodiments, interest data 136 is generated based on other information stored in a member's profile including, but not limited to, the member's history, interests, social connections, and so on.

Once registered, a member may invite other members, or be invited by other members, to connect via the network service. A “connection” may include a bi-lateral agreement by the members, such that both members acknowledge the establishment of the connection. Similarly, with some implementations, a member may elect to “follow” another member. In contrast to establishing a “connection,” the concept of “following” another member typically is a unilateral operation and, at least with some implementations, does not include acknowledgement or approval by the member that is being followed. When one member follows another, the member who is following may receive automatic notifications about various activities undertaken by the member being followed. In addition to following another member, a member may elect to follow a company, a topic, a conversation, or some other entity, which may or may not be included in the social graph. Various other types of relationships may exist between different entities and are represented in the social graph database 138.

The social networking system 120 may provide a broad range of other applications and services that allow members the opportunity to share and receive information, often customized to the interests of the member. In some implementations, the social networking service may include a photo sharing application that allows members to upload and share photos with other members. As such, at least with some implementations, a photograph may be a property or entity included within a social graph. With some implementations, members of a social networking service may be able to self-organize into groups, or interest groups, organized around a subject matter or topic of interest. In some implementations, the data for a group may be stored in a database. When a member joins a group, his or her membership in the group will be reflected in the organization activity data, the member activity data, and the social graph data stored in the social graph database 138.

In some implementations, the application logic layer includes various application server modules, which, in conjunction with the user interface module(s) 122, generates various user interfaces (e.g., web pages) with data retrieved from various data sources in the data layer. With some implementations, individual application server modules are used to implement the functionality associated with various applications, services, and features of the social networking service. For instance, a messaging application, such as an email application, an instant messaging application, or some hybrid or variation of the two, may be implemented with one or more application server modules. Similarly, a search engine enabling members to search for and browse member profiles may be implemented with one or more application server modules. Of course, other applications or services that utilize a candidate analysis module 124 or a recommendation module 126 may be separately implemented in their own application server modules.

In addition to the various application server modules, the application logic layer includes a candidate analysis module 124 and a recommendation module 126. As illustrated in FIG. 1, with some implementations, the candidate analysis module 124 and the recommendation module 126 are implemented as services that operate in conjunction with various application server modules. For instance, any number of individual application server modules can invoke the functionality of the candidate analysis module 124 or the recommendation module 126. However, with various alternative implementations, the candidate analysis module 124 and the recommendation module 126 may be implemented as their own application server modules such that they operate as stand-alone applications. With some implementations, the candidate analysis module 124 and the recommendation module 126 include or have an associated publicly available API that enables third-party applications to invoke the functionality they provide.

Generally, the candidate analysis module 124 receives specific candidate criteria from an education institution and then analyzes data on current members of the social networking system 120 to find one or more members who match the one or more criteria. For example, a law school requests potential candidates that live in the northwest United States, have GPA over 3.5 and a LSAT score over 165.

The candidate analysis module 124 uses these criteria and analyzes stored member qualification data 132 to find matching members. In some example embodiments, member preferences are taken into account. For example, if a member is interested in several other law schools in the northwest, but is not located in the northwest, the candidate analysis module 124 might still determine they are a good match for the law school looking for candidates in the northwest. Conversely, a member who lives in the northwest but is only interested in law schools on the east coast might be determined to not be a good match despite superficially matching the criteria. In some example embodiments, members can explicitly rule out certain schools or regions and will therefore be excluded when trying to find good matches for those schools or regions.

In some example embodiments, the candidate analysis module 124 can perform statistical analysis on all the members interested in a particular education institution for a given time frame. For example, education institution A requests the average qualification data 132 for members of the social networking system 120 interested in attending education institution A next year.

The candidate analysis module 124 then analyzes each member to determine whether the member has indicated interest in education institution A or if such interested can be inferred from the data. The candidate analysis module 124 generates statistics of all the interested students (e.g., high, low, and average scores, work experience) and provides it to the education institution. In some example embodiments, the candidate analysis module 124 can compare the statistical information from a first education institution to other education institutions in its field. For example, if the education institution identifies five peer schools, the candidate analysis module 124 can determine which has the highest incoming freshman GPA and so on.

In some example embodiments, the recommendation module 126 uses stored information about a member's interests, qualifications, location, demographics, and so on, to determine a level of interest for the member in attending a specific education institution.

In some example embodiments, the level of interest is represented as an applicant interest score. A respective education institution can establish a minimum applicant interest score threshold (e.g. to filter out potential applicants with very little likelihood of being interested in the respective education institution). The recommendation module 126 then transmits a list of all the potential applicants with applicant interest scores above the threshold to the education institution for consideration.

In some example embodiments, the education institutions specify a certain number of recommendations that are needed. In this case, the recommendation module 126 ranks all the potential applicants based on applicant interest scores and selects enough top candidates to meet the requested number of potential applicants. In some example embodiments, the recommendation module 126 also considers the qualifications of the potential applicants when ranking each applicant. For example, a member with very high qualifications but only a medium applicant interest score may be ranked higher than a member with low qualifications but a high applicant interest score. In some example embodiments, the recommendation module 126 selects potential applicants based solely on the degree to which they match the one or more criteria set out by the education institution.

In some example embodiments, the recommendation module 126 generates predictions based, at least in part, on the effect that offering a scholarship (e.g., money given to a student to help pay for some or all of the costs of attending an education institution) to a member will have on the member's interest in attending a particular education institution. In some example embodiments, the recommendation module 126 will recommend offering a scholarship (and the size or type of scholarship to be offered) to an education institution based on one or more criteria.

In some example embodiments, the recommendation module 126 will prepare an overall scholarship distribution plan to maximize the quality of the incoming class based on a particular education institution's stated priorities. For example, if a university is interested in attracting an incoming class with the highest possible median SAT score, the recommendation module 126 will calculate the best allocation of scholarship fund to meet this goal (e.g., offer scholarships to members with at least medium interest and high SAT scores, but not necessarily to members with high SAT scores and very high interest in attending (if the member was going to attend anyway, that scholarship money could have been used elsewhere).

In some example embodiments, the education institution server 150 represents a computer system associated with an education institution. The education institution uses the education institution server 150 to communicate with the social networking system 120 and to send and receive data over a network 110. In some example embodiments, the education institution server 150 includes education institution data 152

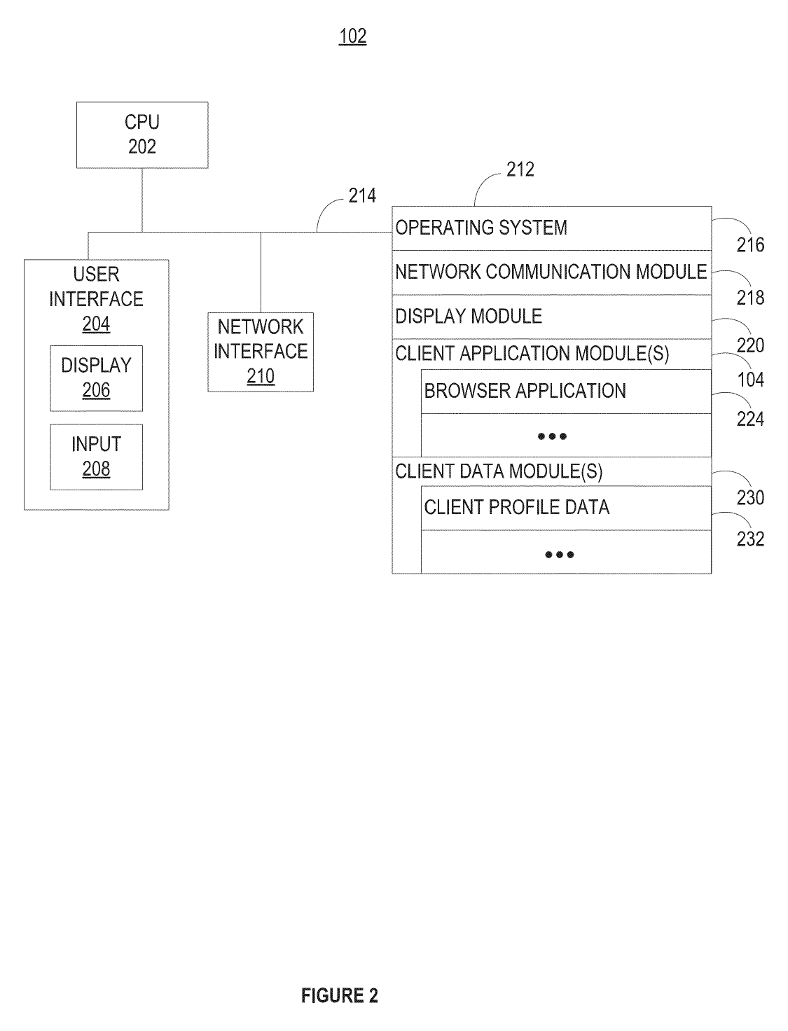

FIG. 2 is a block diagram illustrating a client system 102, in accordance with some implementations. The client system 102 typically includes one or more central processing units (CPUs) 202, one or more network interfaces 210, memory 212, and one or more communication buses 214 for interconnecting these components. The client system 102 includes a user interface 204. The user interface 204 includes a display device 206 and optionally includes an input means such as a keyboard, mouse, a touch sensitive display, or other input buttons 208. Furthermore, some client systems 102 use a microphone and voice recognition to supplement or replace the keyboard.

Memory 212 includes high-speed random access memory, such as dynamic random-access memory (DRAM), static random access memory (SRAM), double data rate random access memory (DDR RAM) or other random access solid state memory devices; and may include non-volatile memory, such as one or more magnetic disk storage devices, optical disk storage devices, flash memory devices, or other non-volatile solid state storage devices. Memory 212 may optionally include one or more storage devices remotely located from the CPU(s) 202. Memory 212, or alternately, the non-volatile memory device(s) within memory 212, comprise(s) a non-transitory computer readable storage medium.

In some implementations, memory 212 or the computer readable storage medium of memory 212 stores the following programs, modules, and data structures, or a subset thereof:
an operating system 216 that includes procedures for handling various basic system services and for performing hardware dependent tasks;
a network communication module 218 that is used for connecting the client system 102 to other computers via the one or more communication network interfaces 210 (wired or wireless) and one or more communication networks 110, such as the Internet, other WANs, LANs, metropolitan area networks (MANs), etc.;
a display module 220 for enabling the information generated by the operating system 216 and client applications 104 to be presented visually on the display device 206;
one or more client applications 104 for handling various aspects of interacting with the social networking system (FIG. 1, 120), including but not limited to:
   a browser application 224 for requesting information from the social networking system 120 (e.g., product pages and member information) and receiving responses from the social networking system 120; and
a client data module 230, for storing data relevant to the clients, including but not limited to:
   client profile data 232 for storing profile data related to a member of the social networking system 120 associated with the client system 102.

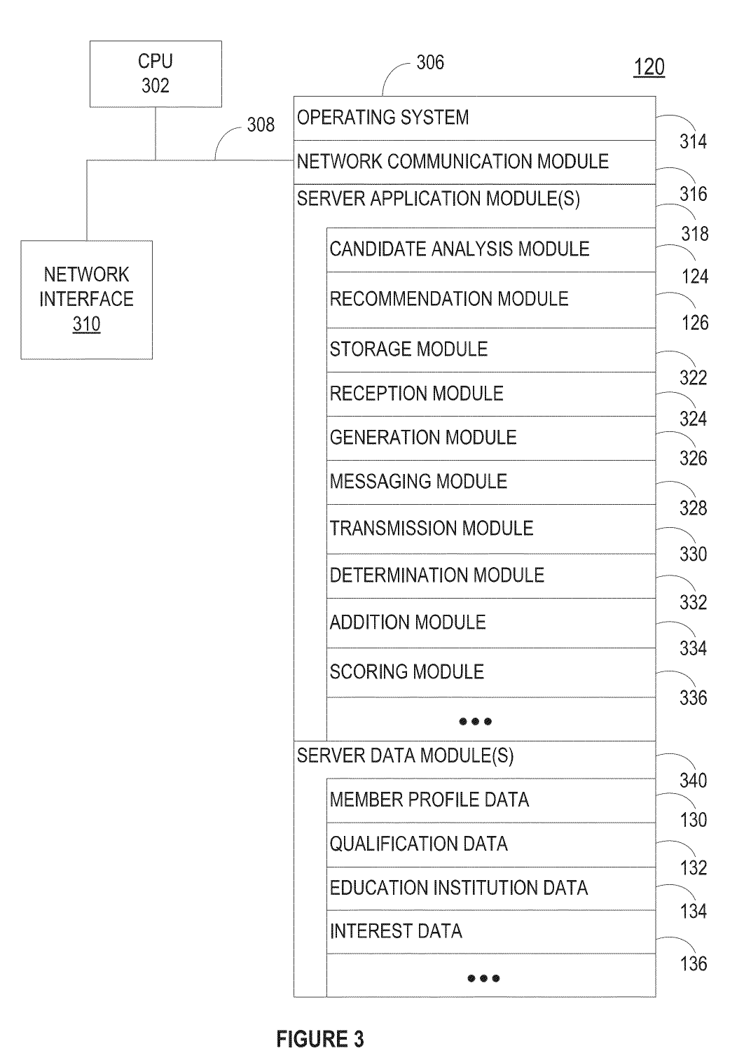

FIG. 3 is a block diagram illustrating a social networking system 120, in accordance with some implementations. The social networking system 120 typically includes one or more CPUs 302, one or more network interfaces 310, memory 306, and one or more communication buses 308 for interconnecting these components. Memory 306 includes high-speed random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 306 may optionally include one or more storage devices remotely located from the CPU(s) 302.

Memory 306, or alternately the non-volatile memory device(s) within memory 306, comprises a non-transitory computer readable storage medium. In some implementations, memory 306 or the computer readable storage medium of memory 306 stores the following programs, modules, and data structures, or a subset thereof:
an operating system 314 that includes procedures for handling various basic system services and for performing hardware dependent tasks;
a network communication module 316 that is used for connecting the social networking system 120 to other computers via the one or more communication network interfaces 310 (wired or wireless) and one or more communication networks 110, such as the Internet, other WANs, LANs, MANs, and so on;
one or more server application modules 318 for performing the services offered by social networking system 120, including but not limited to:
   a candidate analysis module 124 for analyzing member data to determine suitable potential applicants for an education institution based on one or more criteria set by the education institution;
   a recommendation module 126 for generating recommendations for an education institution based on the qualifications and other characteristics of the members and the specifications of the education institution;
   a storage module 322 for receiving and storing member data for a plurality of members of a social networking system 120;
   a reception module 324 for receiving a request from a computer system associated with an education institution;
   a generation module 326 for generating potential applicant data, including but not limited to a list of recommended potential applicants, statistical data for members interested in a respective education institution; and comparison data between two or more education institutions;
   a messaging module 328 for receiving message data from a computer system associated with an education institution including but not limited to e-mail messages, in-system messages, social media messages, text messages, and advertisements;
   a transmission module 330 for transmitting data, including a message or advertisement, to a client system (e.g., system 102 in FIG. 1);
   a determination module 332 for determining, based on data stored for the first member of the social networking system 120, whether the first member meets the received applicant criteria from the first education institution;
   an addition module 334 for adding a respective member of a social networking system 120 to a list of recommended potential applicants; and
   a scoring module 336 for generating an applicant interest score for a particular member of the social networking system 120; and
server data modules 340, holding data related to social networking system 120, including but not limited to:
   member profile data 130 including both data provided by the member who will be prompted to provide some personal information, such as his or her name, age (e.g., birth date), gender, interests, contact information, home town, address, educational background (e.g., schools, majors, etc.), current job title, job description, industry, employment history, skills, professional organizations, memberships to other social networks, customers, past business relationships, and seller preferences; and inferred member information based on member activity, social graph data, overall trend data for the social networking system 120, and so on;
   qualification data 132 including data that represents the various categories of data an education institution might use to determine whether or not to accept an applicant;
   education institution profile data 134 including data describing one or more education institutions (e.g., location, educational programs offer, applicants, alumni, reputation score, etc.); and
   interest data 136 including data representing a member's stated or inferred interest in one or more education institutions.

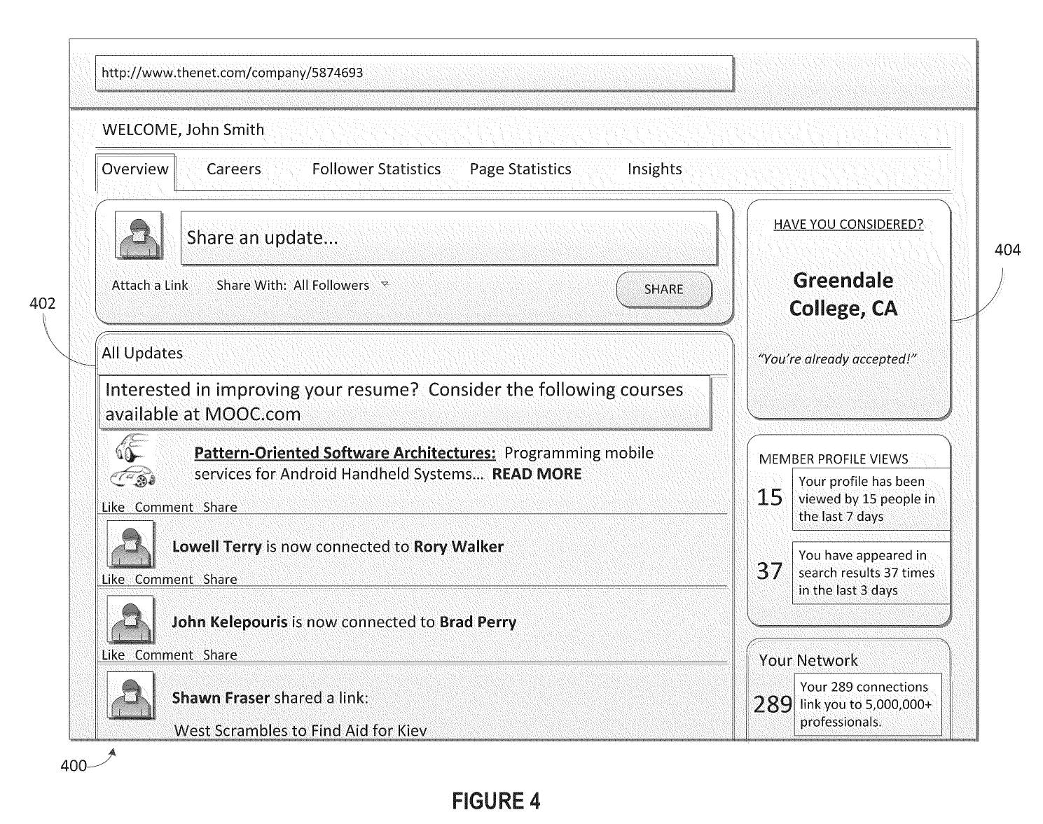

FIG. 4 is a member interface diagram illustrating an example of a user interface 400 in accordance with some example embodiments. The user interface 400 has a stream of updates 402 for the user, including but not limited to, notifications of new social connections, education opportunities, and content shared by other members.

In addition, the generated webpage includes an advertisement 404 for a particular education institution. In some example embodiments, by clicking on the advertisement 404, the client system (e.g., system 120 in FIG. 1) will receive additional information about the education institution that is being advertised.

The user interface 400 also includes information in side sections of the interface including a contact recommendation section, profile viewership statistic section, and a social graph statistic section.

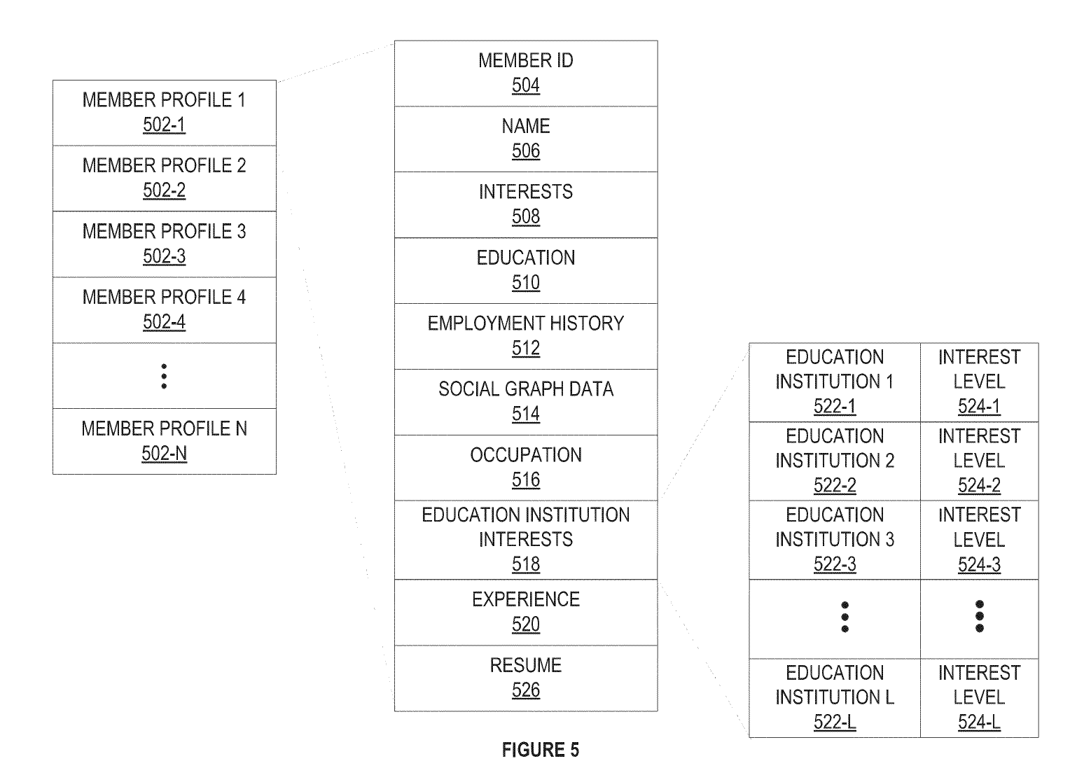

FIG. 5 depicts a block diagram of an exemplary data structure for the member profile data 130 for storing member profiles in accordance with some implementations. In accordance with some implementations, the member profile data 130 includes a plurality of member profiles 502-1 to 502-N, each of which corresponds to a member of the social networking system (FIG. 1, 120).

In some implementations, a respective member profile 502 stores a unique member ID 504 for the member profile 502, a name 506 for the member (e.g., the member's legal name), member interests 508, member education history 510 (e.g., the high school and universities the member attended and the subjects studied), employment history 512 (e.g., member's past and present work history with job titles), social graph data 514 (e.g., a listing of the member's relationships as tracked by the social networking system (FIG. 1, 120)), current occupation 516, education institution interest 518, experience 520 (for listing experiences that don't fit under other categories like community service or serving on the board of a professional organization), and a detailed member resume 526.

In some implementations, a member profile 502 includes a list of education institutions in which the member is interested (522-1 to 522-L) and associated interest levels (524-1 to 524-L). Each education institution represents a specific organization that provides educational opportunities, either in person, on-line, through correspondence, and so on. For example, a member indicates interest in a particular education institution (e.g., by selecting an education institution from a list of potential education institutions). In addition, each education institution has an associated interest level 524. The interest level 524 for a respective education institution represents the member's level of interest in the particular education institution. In some example embodiments, interest level 524 is received from a member's explicit indication. In other example embodiments, education institution interest 518 is determined implicitly based on data in the member profile 502 and the actions of the member.

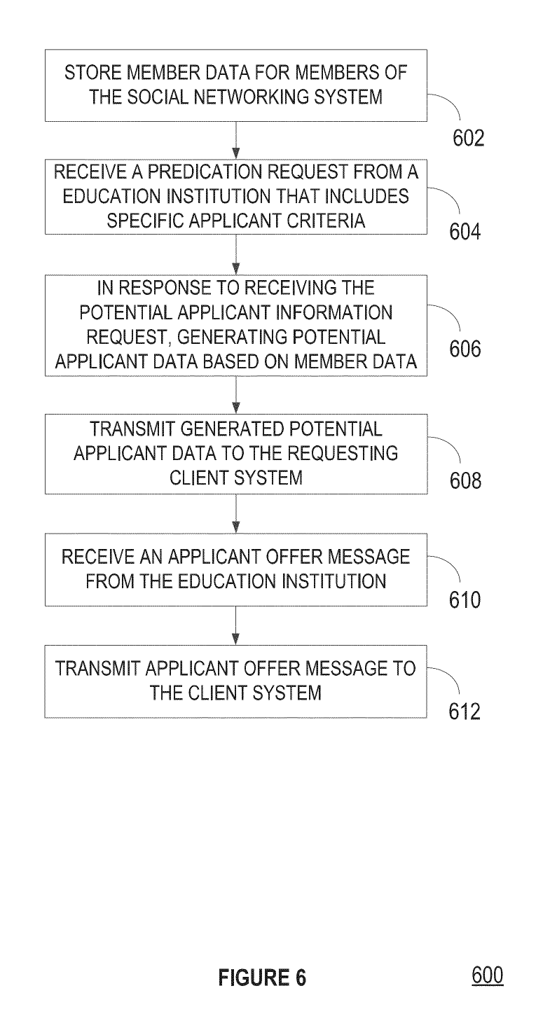

FIG. 6 is a flow diagram illustrating a method, in accordance with some example embodiments, for using large data sets to improve candidate analysis in social networking applications, in accordance with some implementations. Each of the operations shown in FIG. 6 may correspond to instructions stored in a computer memory 306 or computer readable storage medium. Optional operations are indicated by dashed lines (e.g., boxes with dashed-line borders). In some implementations, the method described in FIG. 6 is performed by the social networking system (e.g., system 120 in FIG. 1).

In some implementations, the method is performed at a social networking system (e.g., system 120 in FIG. 1) including one or more processors and memory 306 storing one or more programs for execution by the one or more processors.

The social networking system (e.g., system 120 in FIG. 1) stores (602) member data for a plurality of members of a social networking system 120 at a database associated with the social networking system 120. In some example embodiments, the social networking system (e.g., system 120 in FIG. 1) receives (604) a potential applicant information request from a computer system associated with a first education institution, the request specifying one or more applicant criteria.

In some example embodiments, in response to receiving a potential applicant information request from a computer system associated with the first education institution, the social networking system (e.g., system 120 in FIG. 1) generates (606) potential applicant data based at least in part on the stored member data in the database associated with the social networking system 120.

In some example embodiments, the social networking system (e.g., system 120 in FIG. 1) transmits (608) the generated potential applicant data to the computer system associated with the first education institution. In some example embodiments, the social networking system (e.g., system 120 in FIG. 1) receives (610) an applicant offer message intended for display to at least one member of the social networking system 120. In some example embodiments, the social networking system (e.g., system 120 in FIG. 1) transmits (612) the applicant offer message to a client system 102 associated with at least one member of the social networking system 120 for display.

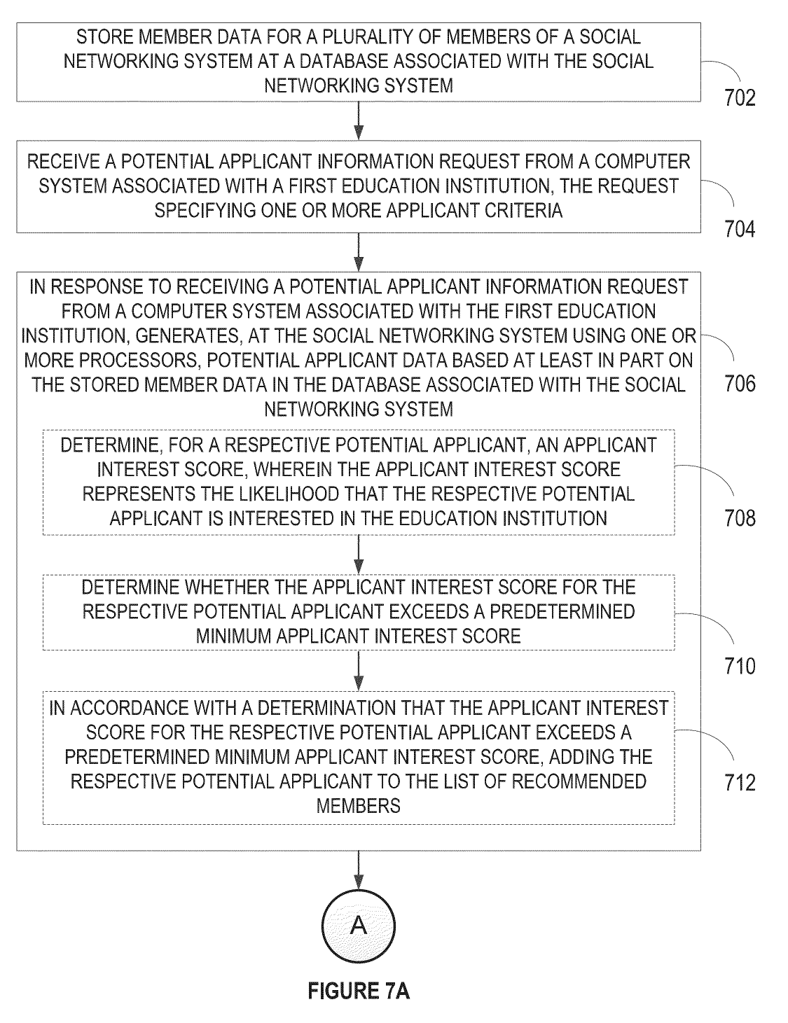

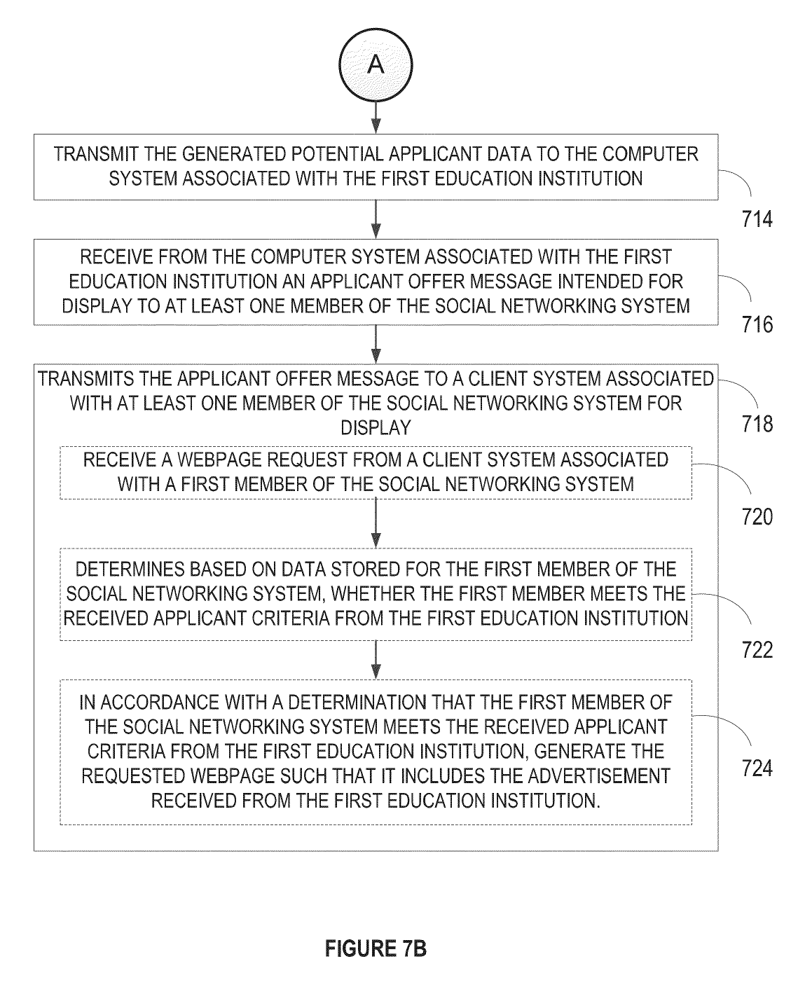

FIG. 7A is a flow diagram illustrating a method, in accordance with some example embodiments, for determining a list of suitable potential applicants for an education institution based on stored data. Each of the operations shown in FIG. 7A may correspond to instructions stored in a computer memory 306 or computer-readable storage medium. Optional operations are indicated by dashed lines (e.g., boxes with dashed-line borders). In some embodiments, the method described in FIG. 7A is performed by the social networking system (e.g., system 120 in FIG. 1). However, the method described can also be performed by any other suitable configuration of electronic hardware.

In some embodiments, the method is performed at a social networking system (e.g., system 120 in FIG. 1) including one or more processors and memory 306 storing one or more programs for execution by the one or more processors.

In some example embodiments, the social networking system (e.g., system 120 in FIG. 1) stores (702) member data for a plurality of members of a social networking system 120 at a database associated with the social networking system 120. In some example embodiments, the stored member data includes the member profile 502. In some example embodiments, the stored member data includes education institution interest data 518 for a plurality of members.

In some example embodiments, the members explicitly select the education institutions of interest to them in a user interface 400 provided by the social networking system (e.g., system 120 in FIG. 1). In other example embodiments, the social networking system (e.g., system 120 in FIG. 1) determines, based on the recorded actions of member (e.g., clicks, likes, views, and so on) and the member profile 502 of the member, implicitly what education institution would be of interest to the member.

In some example embodiments, the social networking system (e.g., system 120 in FIG. 1) uses information known about the group of interested members (e.g., who have explicitly expressed interest in a respective education institution and who pass the education institution's minimum requirements) to identify additional members who have not explicitly expressed interest but nonetheless would be a good match for the respective education institution. For example, the education institution uses a measure of similarity (or distance) from the known interested applicants to determine which members from the group of members that meet the education institutions minimum requirements would be the best match.

One example distance measurement method is using Euclidean distance. Note however, any suitable method or algorithm can be used to compute distance or similarity. Using the Euclidean distance method, the social networking system 120 identifies a group of example members who are known to be good matches for the education institution requirements (based on expressed interests of the members and the fact that they meet or exceed the education institution's minimum requirements.) Each member in the group of example members are then assigned a calculated “coordinate” in a hyperplane system based on the member's features and qualifications. Once all the example members have been mapped onto the hyperplane, the cluster of example members can be analysed to determine a central point (e.g., a centroid which can be seen as representing an average coordinate in the hyperplane for the group of example members).

In some example embodiments, the social networking system 120 then calculates, for one or more members that meet the education institution's minimum requirements but have not expressed explicit interest in the education institution, the similarity/distance score from the central point of the example member cluster. The one or more members then be sorted according to their respective distance/similarity scores and the best matches can be recommend to the education institution as potential applicants worth messaging.

In some example embodiments, only members who have explicitly allowed this information to be shared with education institutions can be recommended in this way.

In some example embodiments, the stored member data includes qualification data 132 for a plurality of members of the social networking system 120. In some example embodiments, qualification data 132 includes, but is not limited to, test scores, demographic data, education history, grades, charitable work, skills, and work history.

In some example embodiments, the social networking system (e.g., system 120 in FIG. 1) receives (704) a potential applicant information request from a computer system associated with a first education institution, the request specifying one or more applicant criteria. In some example embodiments, the one or more specified applicant criteria include one or more of qualification data 132 criteria, interest data 136 criteria, geographic data criteria, and demographic data criteria. For example, the potential application information request seeks members within age range 24 to 28 and that live in the southeast.

In some example embodiments, the potential applicant information request includes a request for a list of potential applicants that match the one or more applicant criteria. For example, the potential application information request includes a request for members with an MCAT score above 28 and with a science undergraduate degree.

In some example embodiments, the potential applicant information request includes a request for statistical information about members who have expressed interest in the first education institution. For example, the potential application information request comes from University A and wants to know the range of work experience, average work experience, and median work experience for all members who have indicated interest in attending University A in the fall of 2023.

In some example embodiments, the potential applicant information request includes a request for statistical information about members who have expressed interest in the education institutions similar to the first education institution. For example, the social networking system (e.g., social networking system 120 of FIG. 1) identifies one or more education institutions that have similar prestige ratings or similar career outcome scores to a first education institution. In some example embodiments, the social networking system (e.g., social networking system 120 of FIG. 1) also considers the geographic location of the education institutions and members.

In some example embodiments, the potential applicant information request includes a request for a list of potential applicants that meet the one or more applicant criteria received from the computer system associated with the education institution and the generated potential applicant data comprises a list of members of the social networking system 120 that meet the applicant criteria.

In some example embodiments, in response to receiving a potential applicant information request from a computer system associated with the first education institution, the social networking system (e.g., system 120 in FIG. 1) generates (706), at the social networking system 120 using one or more processors, potential applicant data based, at least in part, on the stored member data in the database associated with the social networking system (e.g., system 120 in FIG. 1).

In some example embodiments, the generated potential applicant data is a list of recommended members of the social networking system (e.g., system 120 in FIG. 1). In some example embodiments, generating the list of recommended members of the social networking system (e.g., social networking system 120 in FIG. 1) includes determining (708), for a respective potential applicant, an applicant interest score, wherein the applicant interest score represents the likelihood that the respective potential applicant is interested in the education institution. In some example embodiments, the applicant interest score for a first member in a first education institution is based on the first member profile 502, interest directly expressed by the first member in the first education institution or other education institution, and actions taken by the first member.

In some example embodiments, the social networking system (e.g., social networking system 120 in FIG. 1) determines (710) whether the applicant interest score for the respective potential applicant exceeds a predetermined minimum applicant interest score. For example, an applicant interest score is a number between 0 and 1, with 0 being no interest and 1 being the highest measurable interest. The social networking system (e.g., system 120 in FIG. 1) determines that only members with an interest score above 0.35 should be reported to the education institution.

In some example embodiments, in accordance with a determination that the applicant interest score for the respective potential applicant exceeds a predetermined minimum applicant interest score, the social networking system (e.g., system 120 in FIG. 1) adds (712) the respective potential applicant to the list of recommended members.

FIG. 7B is a flow diagram illustrating a method, in accordance with some example embodiments, for determining a list of suitable potential applicants for an education institution based on stored data. Each of the operations shown in FIG. 7B may correspond to instructions stored in a computer memory 306 or computer-readable storage medium. Optional operations are indicated by dashed lines (e.g., boxes with dashed-line borders). In some embodiments, the method described in FIG. 7B is performed by the social networking system (e.g., system 120 in FIG. 1). However, the method described can also be performed by any other suitable configuration of electronic hardware.

In some embodiments, the method is performed at a social networking system (e.g., system 120 in FIG. 1) including one or more processors and memory 306 storing one or more programs for execution by the one or more processors.

In some example embodiments, the social networking system (e.g., system 120 in FIG. 1) transmits (714), to the request system associated with an education institution, the generated potential applicant data. For example, the social networking system (e.g., system 120 in FIG. 1) selects the five hundred best matches (based on applicant qualifications and interest) and send a list of those selected members to the education institution.

In some example embodiments, the social networking system 120 maintains a list of each education institution's preferences and requirements for potential applicants. Then, when a member who is a good match and meets the established requirements for a particular education institution is found, the education institution. In some example embodiments, recommendations are only send to education institutions if the education institution explicitly allows such recommendations to be sent.

In some example embodiments, the social networking system (e.g., system 120 in FIG. 1) receives (716), from the computer system associated with the first education institution, an applicant offer message intended for display to at least one member of the social networking system 120. In some example embodiments, the received applicant offer message is an advertisement 404 intended for a plurality of members of the social networking system 120. For example, the education institution sends an advertisement 404 to be displayed to any member that meets a minimum set of qualifications.

In some example embodiments, the received generated potential applicant data is a list of recommended members of the social networking system 120 and the applicant offer message is a personalized message to a member in the list of recommended members. Thus, an education institution can create direct messages or emails to specific members, with the purpose of generating member interest in their particular education institution.

In some example embodiments, the social networking system (e.g., social networking system 120 in FIG. 1) transmits (718) the applicant offer message to a client system 102 associated with at least one member of the social networking system 120 for display.

In some example embodiments, transmitting the offer message to the applicant comprises, the social networking system (e.g., system 120 in FIG. 1) receiving (720) a webpage request from a client system 102 associated with a first member of the social networking system 120. For example, a member of the social networking system (e.g., system 120 in FIG. 1) submits a request for the member's profile page.

In some example embodiments, the social networking system (e.g., social networking system 120 in FIG. 1) determines (722), based on data stored for the first member of the social networking system 120, whether the first member meets the received applicant criteria from the first education institution. For example, the first education institution is Law School A and the applicant criteria that only members who have are at least third year students at a university or have recently graduated and live in Oregon should be shown a particular advertisement 404. The social networking system (e.g., system 120 in FIG. 1) then determines, for each member requesting a page, whether the member meets these qualifications.

In some example embodiments, in accordance with a determination that the first member of the social networking system 120 meets the received applicant criteria from the first education institution, the social networking system (e.g., system 120 in FIG. 1) generates (724) the requested webpage such that it includes the advertisement 404 received from the first education institution. For example, the member requests a webpage including an activity feed. The social networking system (e.g., system 120 in FIG. 1) generates the web page with the activity feed and includes one or more advertisements 404 in areas of the webpage that are designated for advertisements 404. As above, the member meets the specifications set by education institution A and, as such, one of the selected advertisements 404 is the advertisement 404 (e.g., message) from education institution A.

In some example embodiments, the message is a personalized message and the personalized message is transmitted to the member as an email message, an in-system message, or a text message. In some example embodiments, the personalized message is written by a member associated with the education institution.

### Software Architecture

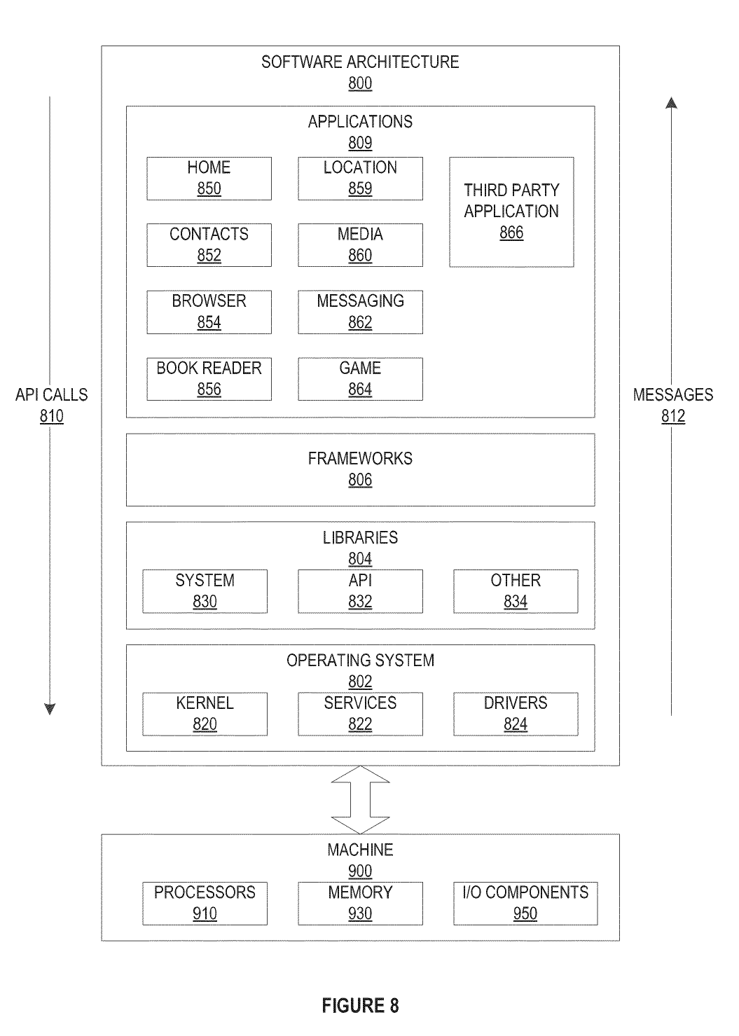

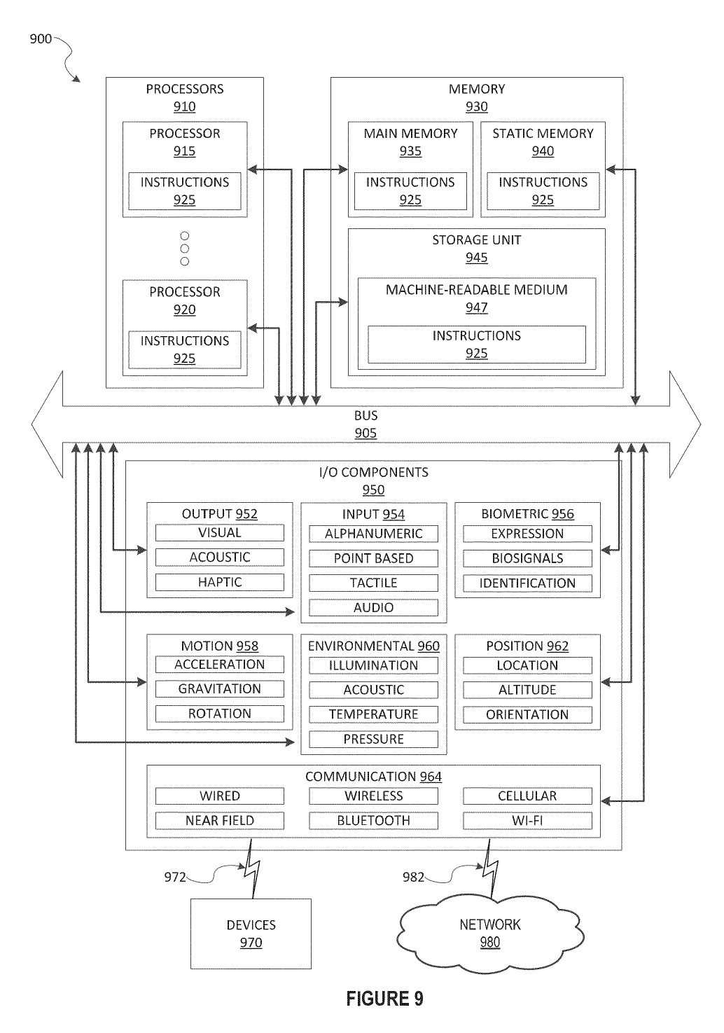

FIG. 8 is a block diagram illustrating an architecture of software 800, which may be installed on any one or more of the devices of FIG. 1 (e.g., client device(s) 110). FIG. 8 is merely a non-limiting example of a software architecture 800 and it will be appreciated that many other architectures may be implemented to facilitate the functionality described herein. The software 800 may be executing on hardware such as machine 900 of FIG. 9 that includes processors 910, memory 930, and I/O components 950. In the example architecture of FIG. 8, the software 800 may be conceptualized as a stack of layers where each layer may provide particular functionality. For example, the software 800 may include layers such as an operating system 802, libraries 804, frameworks 806, and applications 808. Operationally, the applications 809 may invoke API calls 810 through the software stack and receive messages 812 in response to the API calls 810.

The operating system 802 may manage hardware resources and provide common services. The operating system 802 may include, for example, a kernel 820, services 822, and drivers 824. The kernel 820 may act as an abstraction layer between the hardware and the other software layers. For example, the kernel 820 may be responsible for memory management, processor management (e.g., scheduling), component management, networking, security settings, and so on. The services 822 may provide other common services for the other software layers. The drivers 824 may be responsible for controlling and/or interfacing with the underlying hardware. For instance, the drivers 824 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 804 may provide a low-level common infrastructure that may be utilized by the applications 809. The libraries 804 may include system libraries 830 (e.g., C standard library) that may provide functions such as memory allocation functions, string manipulation functions, mathematic functions, and the like. In addition, the libraries 804 may include API libraries 832 such as media libraries (e.g., libraries to support presentation and manipulation of various media formats such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 804 may also include a wide variety of other libraries 834 to provide many other APIs to the applications 809.

The frameworks 806 may provide a high-level common infrastructure that may be utilized by the applications 809. For example, the frameworks 806 may provide various graphical user interface (GUI) functions, high-level resource management, high-level location services, and so forth. The frameworks 806 may provide a broad spectrum of other APIs that may be utilized by the applications 809, some of which may be specific to a particular operating system 802 or platform.

The applications 809 include a home application 850, a contacts application 852, a browser application 854, a book reader application 856, a location application 859, a media application 860, a messaging application 862, a game application 864, and a broad assortment of other applications such as third party application 866. In a specific example, the third party application 866 (e.g., an application developed using the Android™ or iOS™ software development kit (SDK) by an entity other than the vendor of the particular platform) may be mobile software running on a mobile operating system 802 such as iOS™, Android™, Windows® Phone, or other mobile operating systems 802. In this example, the third party application 866 may invoke the API calls 810 provided by the mobile operating system 802 to facilitate functionality described herein.

### Example Machine Architecture and Machine-Readable Medium

FIG. 9 is a block diagram illustrating components of a machine 900, according to some example embodiments, able to read instructions from a machine-readable medium (e.g., a machine-readable storage medium) and perform any one or more of the methodologies discussed herein. Specifically, FIG. 9 shows a diagrammatic representation of the machine 900 in the example form of a computer system, within which instructions 925 (e.g., software 800, a program, an application, an applet, an app, or other executable code) for causing the machine 900 to perform any one or more of the methodologies discussed herein may be executed. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but be not limited to, a server computer, a client computer, a (PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 925, sequentially or otherwise, that specify actions to be taken by machine 900. Further, while only a single machine 900 is illustrated, the term “machine” shall also be taken to include a collection of machines 900 that individually or jointly execute the instructions 925 to perform any one or more of the methodologies discussed herein.

The machine 900 may include processors 910, memory 930, and I/O components 950, which may be configured to communicate with each other via a bus 905. In an example embodiment, the processors 910 (e.g., a CPU, a reduced instruction set computing (RISC) processor, a complex instruction set computing (CISC) processor, a graphics processing unit (GPU), a digital signal processor (DSP), an application specific integrated circuit (ASIC), a radio-frequency integrated circuit (RFIC), another processor, or any suitable combination thereof) may include, for example, processor 915 and processor 920, which may execute instructions 925. The term “processor” is intended to include multi-core processors 910 that may comprise two or more independent processors 915, 920 (also referred to as “cores”) that may execute instructions 925 contemporaneously. Although FIG. 9 shows multiple processors, 910 the machine 900 may include a single processor 910 with a single core, a single processor 910 with multiple cores (e.g., a multi-core process), multiple processors 910 with a single core, multiple processors 910 with multiples cores, or any combination thereof.

The memory 930 may include a main memory 935, a static memory 940, and a storage unit 945 accessible to the processors 910 via the bus 905. The storage unit 945 may include a machine-readable medium 947 on which are stored the instructions 925 embodying any one or more of the methodologies or functions described herein. The instructions 925 may also reside, completely or at least partially, within the main memory 935, within the static memory 940, within at least one of the processors 910 (e.g., within the processor's cache memory), or any suitable combination thereof, during execution thereof by the machine 900. Accordingly, the main memory 935, static memory 940, and the processors 910 may be considered as machine-readable media 947.

As used herein, the term “memory” refers to a machine-readable medium 947 able to store data temporarily or permanently and may be taken to include, but not be limited to, random-access memory (RAM), read-only memory (ROM), buffer memory, flash memory, and cache memory. While the machine-readable medium 947 is shown, in an example embodiment, to be a single medium, the term “machine-readable medium” should be taken to include a single medium or multiple media (e.g., a centralized or distributed database, or associated caches and servers) able to store instructions 925. The term “machine-readable medium” shall also be taken to include any medium, or combination of multiple media, that is capable of storing instructions (e.g., instructions 925) for execution by a machine (e.g., machine 900), such that the instructions 925, when executed by one or more processors of the machine 900 (e.g., processors 910), cause the machine 900 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term “machine-readable medium” specifically excludes non-statutory signals per se.

The I/O components 950 may include a wide variety of components to receive input, provide and/or produce output, transmit information, exchange information, capture measurements, and so on. It will be appreciated that the I/O components 950 may include many other components that are not shown in FIG. 9. In various example embodiments, the I/O components 950 may include output components 952 and/or input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 954 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or other pointing instrument), tactile input components (e.g., a physical button, a touch screen that provides location and force of touches or touch gestures, and/or other tactile input components), audio input components (e.g., a microphone), and the like.

In further example embodiments, the I/O components 950 may include biometric components 956, motion components 958, environmental components 960, and/or position components 962, among a wide array of other components. For example, the biometric components 956 may include components to detect expressions (e.g., hand expressions, facial expressions, vocal expressions, body gestures, or eye tracking), measure bio signals (e.g., blood pressure, heart rate, body temperature, perspiration, or brain waves), identify a person (e.g., voice identification, retinal identification, facial identification, finger print identification, or electroencephalogram based identification), and the like. The motion components 958 may include acceleration sensor components (e.g., accelerometer), gravitation sensor components, rotation sensor components (e.g., gyroscope), and so forth. The environmental components 960 may include, for example, illumination sensor components (e.g., photometer), acoustic sensor components (e.g., one or more microphones that detect background noise), temperature sensor components (e.g., one or more thermometers that detect ambient temperature), humidity sensor components, pressure sensor components (e.g., barometer), proximity sensor components (e.g., infrared sensors that detect nearby objects), and/or other components that may provide indications, measurements, and/or signals corresponding to a surrounding physical environment. The position components 962 may include location sensor components (e.g., a Global Position System (GPS) receiver component), altitude sensor components (e.g., altimeters and/or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 and/or devices 970 via coupling 982 and coupling 972, respectively. For example, the communication components 964 may include a network interface component or other suitable device to interface with the network 980. In further examples, communication components 964 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 970 may be another machine 900 and/or any of a wide variety of peripheral devices (e.g., a peripheral device coupled via a USB).

Moreover, the communication components 964 may detect identifiers and/or include components operable to detect identifiers. For example, the communication components 964 may include radio frequency identification (RFID) tag reader components, NFC smart tag detection components, optical reader components (e.g., an optical sensor to detect one-dimensional bar codes such as Universal Product Code (UPC) bar codes, multi-dimensional bar codes such as a Quick Response (QR) code, Aztec code, Data Matrix, Dataglyph, MaxiCode, PDF48, Ultra Code, UCC RSS-2D bar code, and other optical codes), acoustic detection components (e.g., microphones to identify tagged audio signals), and so on. In additional, a variety of information may be derived via the communication components 964 such as location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 980 may be an ad hoc network, an intranet, an extranet, a virtual private network (VPN), a LAN, a wireless LAN (WLAN), a WAN, a wireless WAN (WWAN), a MAN, the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 980 or a portion of the network 980 may include a wireless or cellular network and the coupling 982 may be a Code Division Multiple Access (CDMA) connection, a Global System for Mobile communications (GSM) connection, or other type of cellular or wireless coupling. In this example, the coupling 982 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 925 may be transmitted and/or received over the network 980 using a transmission medium via a network interface device (e.g., a network interface component included in the communication components 964) and utilizing any one of a number of well-known transfer protocols (e.g., HyperText Transfer Protocol (HTTP)). Similarly, the instructions 925 may be transmitted and/or received using a transmission medium via the coupling 972 (e.g., a peer-to-peer coupling) to devices 970. The term “transmission medium” shall be taken to include any intangible medium that is capable of storing, encoding, or carrying instructions 925 for execution by the machine 900, and includes digital or analog communications signals or other intangible medium to facilitate communication of such software 800.

Furthermore, the machine-readable medium 947 is non-transitory (in other words, not having any transitory signals) in that it does not embody a propagating signal. However, labeling the machine-readable medium 947 as “non-transitory” should not be construed to mean that the medium is incapable of movement; the medium should be considered as being transportable from one physical location to another. Additionally, since the machine-readable medium 947 is tangible, the medium may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for purpose of explanation, has been described with reference to specific implementations. However, the illustrative discussions above are not intended to be exhaustive or to limit the possible implementations to the precise forms disclosed. Many modifications and variations are possible in view of the above teachings. The implementations were chosen and described in order to best explain the principles involved and their practical applications, to thereby enable others skilled in the art to best utilize the various implementations with various modifications as are suited to the particular use contemplated.

It will also be understood that, although the terms first, second, and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present implementations. The first contact and the second contact are both contacts, but they are not the same contact.

The terminology used in the description of the implementations herein is for the purpose of describing particular implementations only and is not intended to be limiting. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if (a stated condition or event) is detected” may be construed to mean “upon determining” or “in response to determining” or “upon detecting (the stated condition or event)” or “in response to detecting (the stated condition or event),” depending on the context.

1. A method comprising:
storing member data for a plurality of members of a social networking system at a database associated with the social networking system;
receiving a potential applicant information request from a computer system associated with a first education institution, the request specifying one or more applicant criteria;
in response to receiving a potential applicant information request from a computer system associated with the first education institution, generating, at the social networking system using one or more processors, potential applicant data based at least in part on the stored member data in the database associated with the social networking system;
transmitting the generated potential applicant data to the computer system associated with the first education institution;
receiving, from the computer system associated with the first education institution, an applicant offer message intended for display to at least one member of the social networking system; and
transmitting the applicant offer message to a client system associated with at least one member of the social networking system for display.

2. The method of claim 1, wherein the stored member data includes education institution interest data for a plurality of members.

3. The method of claim 1, wherein the stored member data includes qualification data for a plurality of members of the social networking system.

4. The method of claim 1, wherein the one or more specified applicant criteria include one or more of qualification data criteria, interest data criteria, geographic data criteria, and demographic data criteria.

5. The method of claim 1, wherein the potential applicant information request includes a request for a list of potential applicants that match the one or more applicant criteria.

6. The method of claim 4, wherein the potential applicant information request includes a request for statistical information about members who have expressed interest in the first education institution.

7. The method of claim 1, further comprising transmitting the generated potential applicant data to the computer system associated with the first education institution

8. The method of claim 1, wherein the received applicant offer message is an advertisement intended for a plurality of members of the social networking system.

9. The method of claim 8, wherein transmitting the offer message to the applicant comprises:
receiving a webpage request from a client system associated with a first member of the social networking system;
determining, based on the member data stored for the first member of the social networking system, whether the first member meets the received applicant criteria from the first education institution; and
in accordance with a determination that the first member of the social networking system meets the received applicant criteria from the first education institution, generating the requested webpage such that it includes the advertisement received from the first education institution.

10. The method of claim 1, wherein the generated potential applicant data includes potential applicant information request includes a request for a list of potential applicant that meet the one or more applicant criteria received from the computer system associated with the education institution and the generated potential applicant data comprises a list of members of the social networking system that meet the applicant criteria.

11. The method of claim 1, wherein the generated potential applicant data is a list of recommended members of the social networking system and the applicant offer message is a personalized message to a member in the list of recommended members.

12. The method of claim 11, wherein the personalized message is transmitted to the member as an email message, an in-system message, or a text message.

13. The method of claim 1, wherein the generated potential applicant data is a list of recommended members of the social networking system, and generating the list of recommended members of the social networking system includes:
determining, for a respective potential applicant, an applicant interest score, wherein the applicant interest score represents the likelihood that the respective potential applicant is interested in the education institution;
determining whether the applicant interest score for the respective potential applicant exceeds a predetermined minimum applicant interest score; and
in accordance with a determination that the applicant interest score for the respective potential applicant exceeds a predetermined minimum applicant interest score, adding the respective potential applicant to the list of recommended members.

14. A system comprising:
one or more processors;
memory; and
one or more programs stored in the memory, the one or more programs comprising instructions for:
storing member data for a plurality of members of a social networking system at a database associated with the social networking system;
receiving a potential applicant information request from a computer system associated with a first education institution, the request specifying one or more applicant criteria;
in response to receiving a potential applicant information request from a computer system associated with the first education institution, generating, at the social networking system using one or more processors, potential applicant data based at least in part on the stored member data in the database associated with the social networking system;
transmitting the generated potential applicant data to the computer system associated with the first education institution;
receiving, from the computer system associated with the first education institution, an applicant offer message intended for display to at least one member of the social networking system; and
transmitting the applicant offer message to a client system associated with at least one member of the social networking system for display.

15. The system of claim 14, wherein the stored member data includes education institution interest data for a plurality of members.

16. The system of claim 14, wherein the stored member data includes qualification data for a plurality of members of the social networking system.

17. The system of claim 14, wherein the one or more specified applicant criteria include one or more of qualification data criteria, interest data criteria, geographic data criteria, and demographic data criteria.

18. A non-transitory computer readable storage medium storing one or more programs for execution by one or more processors, the one or more programs comprising instructions for:
storing member data for a plurality of members of a social networking system at a database associated with the social networking system;
receiving a potential applicant information request from a computer system associated with a first education institution, the request specifying one or more applicant criteria;
in response to receiving a potential applicant information request from a computer system associated with the first education institution, generating, at the social networking system using one or more processors, potential applicant data based at least in part on the stored member data in the database associated with the social networking system;
transmitting the generated potential applicant data to the computer system associated with the first education institution;
receiving, from the computer system associated with the first education institution, an applicant offer message intended for display to at least one member of the social networking system; and
transmitting the applicant offer message to a client system associated with at least one member of the social networking system for display.

19. The non-transitory computer readable storage medium of claim 18, wherein the stored member data includes education institution interest data for a plurality of members.

20. The non-transitory computer readable storage medium of claim 18, wherein the stored member data includes qualification data for a plurality of members of the social networking system.
